(19) United States
(12) Patent Application Publication
(10) Pub. No.: US 2005/0170131 A1
(43) Pub. Date: Aug. 4, 2005

(54) Slat structure for blind

(76) Inventor: Leslie Nien, Changhua Hsien (TW)

Correspondence Address: TROXELL LAW OFFICE PLLC, SUITE 1404, 5205 LEESBURG PIKE, FALLS CHURCH, VA, 22041, US

(21) Appl. No.: 10/860,005

(22) Filed: Jun. 4, 2004

(30) Foreign Application Priority Data
Jan. 30, 2004 (CN) 093201374

(51) Int. Cl. B32B 3/10

(52) U.S. Cl. 428/54

(57) ABSTRACT

A slat structure for blind includes a plurality of support rods/boards of bamboo material each alternatively lined up side by side with one or more than one decoration rolls and firmly bound together therewith via laterally extending retaining threads tightly woven in equal distance at the juxtaposed support rods and decoration rolls thereon to provide a slat structure for a blind embodiment of various kinds (such as a vertical-type/horizontal-type Venetian blind, a rolling blind, or a Roman blind, etc.). The decoration roll is made up of more than one decoration strips that, made of yarns, paper rolls, or strings, etc., are closed intertwined and bound together with a plurality of protrusions and recesses formed at the surface thereon, and a solid penetrating plasma material is coated on the outer surface of the decoration roll to form a rigid and straight texture thereon, permitting the slat to look three-dimensional as a whole with protruded and recessed patterns variously displayed at the surface thereon in difference from a conventional slat structure so as to boost the competitive power and the value of the present invention in the market.

### BACKGROUND OF THE INVENTION

The present invention is related to a slat structure for blind, including a plurality of support rods/boards of bamboo material each alternatively lined up side by side with one or more than one decoration rolls and firmly bound together therewith via laterally extending retaining threads tightly woven in equal distance at the juxtaposed support rods and decoration rolls thereon to provide a slat structure for a blind embodiment of various kinds (such as a vertical-type/horizontal-type Venetian blind, a rolling blind, or a Roman blind, etc.). The decoration roll is made up of more than one decoration strips that are closely intertwined together with a plurality of protrusions and recesses formed at the surface thereon, and a solid penetrating plasma material is coated on the outer surface of the decoration roll to form a rigid and straight texture thereon, permitting the slat to look three-dimensional in display so as to boost the competitive power and the value of the present invention in the market.

A conventional slat structure for blind is usually made of plastic material that is molded into an elongated and solid slat piece of proper strength and hardness for a vertical-type or horizontal-type blind. The horizontal-type or vertical-type slat piece is further processed via printing or hot-pressing to apply diagrams onto the surfaces thereof for beautiful display before cord passage holes are punched at the slat pieces thereon for retaining cords to be led there-through. However, after long time of repeated friction of the slat pieces in use, the diagrams printed at the slats thereon can easily come or wear off, which not only mars the beauty of the blind as a whole, but also reduces the using lifespan of the slat pieces thereof. Besides, the horizontal-type or vertical type slat pieces, made of plastics, can increase the burden of the environment in recycle. When burned off in disposal, the slat pieces thereof can also cause air pollution and harm the environment. Finally, diagrams are dully printed at the plane surfaces of the slats thereon without any three-dimensional texture displayed thereon for variation.

### SUMMARY OF THE PRESENT INVENTION

It is, therefore, the primary purpose of the present invention to provide a slat structure for blind, including a plurality of support rods/boards of bamboo material each alternatively lined up side by side with one or more than one decoration rolls and firmly bound together therewith via retaining threads tightly woven in equal distance at the juxtaposed support rods and decoration rolls thereon wherein the decoration roll is made up of more than one decoration strips that are closed intertwined together with protrusions and recesses formed at the surface thereon, permitting the slat thereof to display a three-dimensional texture in difference from a conventional slat structure so as to boost the competitive power and the value of the blind thereof in the market.

It is, therefore, the second purpose of the present invention to provide a slat structure for blind wherein the support rods and the decoration rolls are alternatively juxtaposed and firmly bound together via the retaining threads thereof to provide a slat structure for a blind embodiment of various kinds such as a vertical-type/horizontal-type Venetian blind, a rolling blind, or a Roman blind, etc., achieving a widespread use of the present invention thereof.

It is, therefore, the third purpose of the present invention to provide a slat structure for blind wherein the blind embodiment made up of the support rods of bamboo material, the retaining threads, and the decoration rolls of yarns, paper rolls, or strings, etc., are easily disposed of in recycle or burning off without causing any burden or air pollution to the environment to provide an eco-friendly slat structure for blind thereof.

### BRIEF DESCRIPTION OF THE DRAWINGS

FIG. 1 is a perspective view of the present invention.

FIG. 2 is a plane view of a decoration roll of the present invention.

FIG. 3 is a cross sectional view of the decoration roll of the present invention.

FIG. 4 is a perspective view of another embodiment of the present invention.

FIG. 5 is a perspective view of a third embodiment of the present invention.

### DETAILED DESCRIPTION OF THE PREFERRED EMBODIMENTS

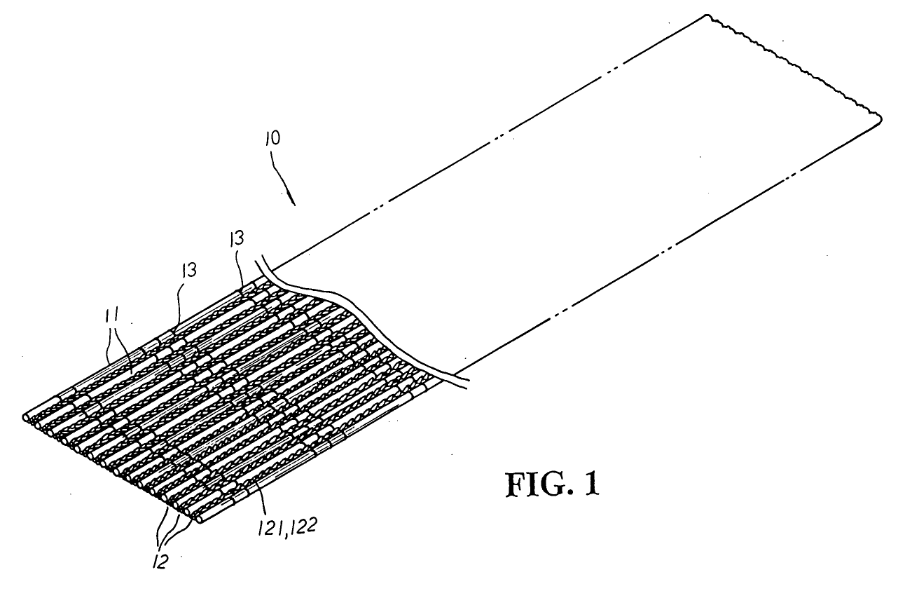

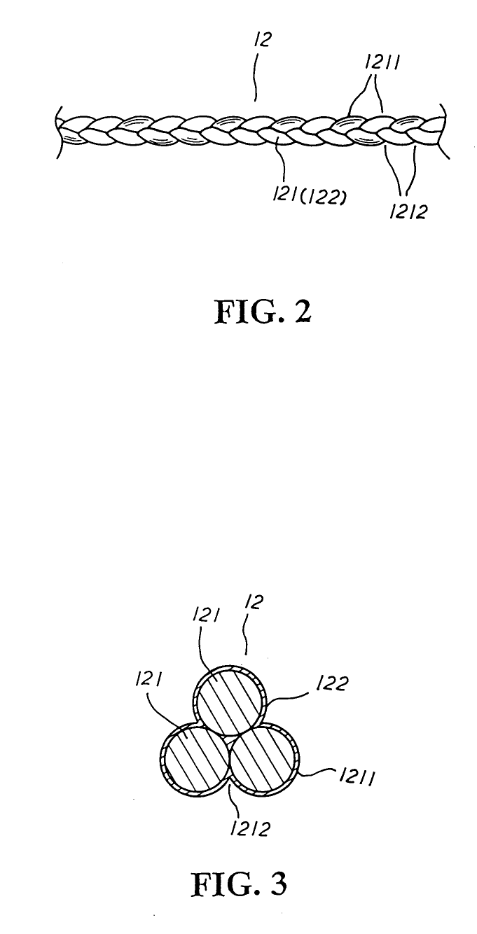

Please refer to FIGS. 1 to 3 inclusive. The present invention is related to a slat structure for blind, including a plurality of support rods 11 of bamboo material each alternatively lined up side by side with one or more than one decoration rolls 12 and firmly bound together therewith via retaining threads 13 laterally extending in equal distance at the juxtaposed support rods 11 and the decoration rolls 12 thereon. Thus, the support rods 11 and the decoration rolls 12 thereof are tightly abutted one against another via the retaining threads 13 securely woven thereon to form a vertical-type or horizontal-type blind slat 10 of proper width. Each of the decoration roll 12 is made up of more than one decoration strips 121 that are closed intertwined and bound together with a plurality of protrusions 1211 and recesses 1212 formed at the superficial surface of the decoration roll 12 thereon as shown in FIGS. 2, 3. Besides, the decoration strip 121 can be made of yarns, paper rolls, or strings, and a solid penetrating plasma material 122 is coated on the outer surface of the decoration strip 121 to form a rigid and straight texture thereon. As a result, the slat 10, different from a plane conventional slat, is made to look three-dimensional as a whole with protruded and recessed patterns variously displayed at the surface thereon. The slats 10 thereof are capable of being further assembled into a blind embodiment (such as a vertical-type, or a horizontal-type Venetian blind, etc.) so as to boost the competitive power and the value of the present invention thereof.

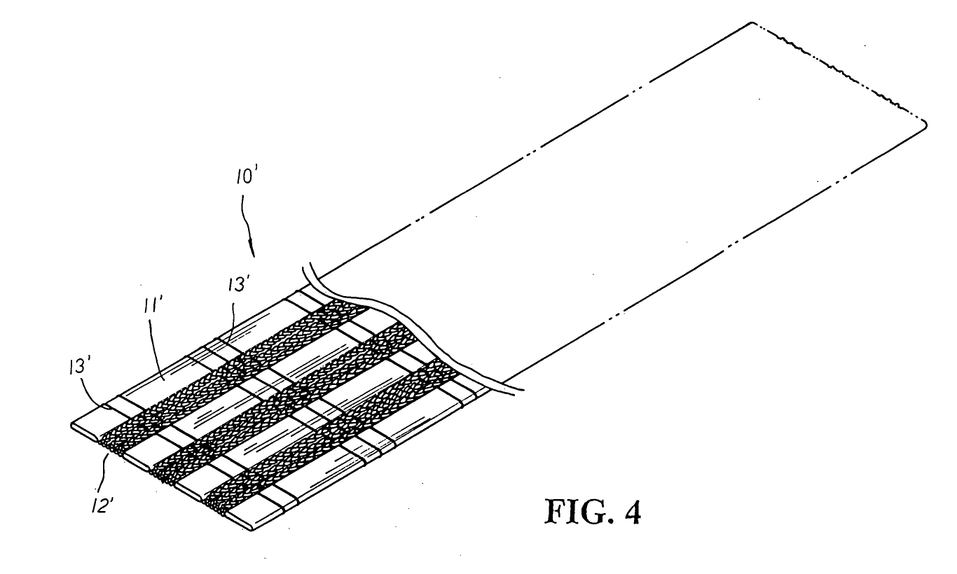

Please refer to FIG. 4. The present invention can also include a slat 10′ made up of a plurality of support boards 11′ of bamboo material each alternatively lined up side by side with more than one decoration rolls 12′ and firmly bound together therewith via retaining threads 13′ woven closely and equidistantly at the juxtaposed support boards 11′ and the decoration rolls 12′ thereon. The slats 10′ thereof are then further assembled into a blind embodiment like a vertical-type or a horizontal-type Venetian blind, etc.

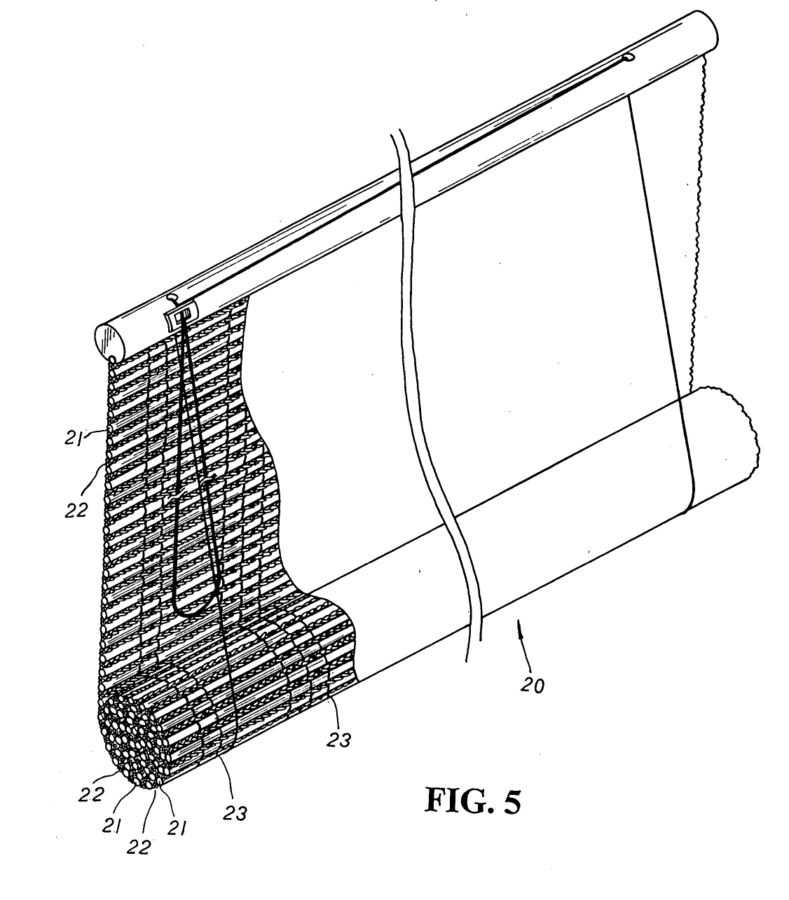

Please refer to FIG. 5. The present invention can also be equipped with a plurality of support rods 21 and decoration rolls 22 that are alternatively lined up side by side in a series and integrally bound tight via retaining threads 23 closely intertwined and woven at the juxtaposed support rods 21 and the decoration rolls 22 thereon to form a blind embodiment that is capable of being rolled up or stretched down as a whole, or to form a Roman blind (without shown in the diagram).

1. A slat structure for blind, including a plurality of support rods/boards of bamboo material each alternatively lined up side by side with one or more than one decoration rolls and firmly bound together therewith via laterally extending retaining threads closely woven in equal distance at the juxtaposed support rods and decoration rolls thereon to provide a slat structure for a blind embodiment of various kinds (such as a vertical-type/horizontal-type Venetian blind, a rolling blind, or a Roman blind, etc.); the present invention being characterized by that,
the decoration roll being made up of more than one decoration strips that are tightly intertwined and bound together with a plurality of protrusions and recesses formed at the superficial surface thereon; a solid penetrating plasma material being coated on the outer surface of the decoration roll to form a rigid and straight texture thereon, permitting the slat to look three-dimensional as a whole with protruded and recessed patterns variously displayed at the surface thereon in difference from a conventional slat structure so as to boost the competitive power and the value of the present invention in the market.

2. The slat structure for blind as claimed in claim 1 wherein the decoration strips of the decoration roll thereof can be made of yarns, paper rolls, or strings, etc.

3. The slat structure for blind as claimed in claim 1 wherein the decoration strips of the decoration roll thereof are better bound together via intertwining and weaving operation thereof.
